(19) United States
(12) Patent Application Publication
(10) Pub. No.: US 2026/0369542 A1
(43) Pub. Date: Nov. 19, 2026

(54) METHOD OF MANUFACTURING STRIP-SHAPED ELECTRODE PLATE AND DRYING APPARATUS

(71) Applicant: Prime Planet Energy & Solutions, Inc., Tokyo (JP)

(72) Inventor: Yusuke OKUHATA, Toyota-shi (JP)

(21) Appl. No.: 19/643,800

(22) Filed: Apr. 10, 2026

(30) Foreign Application Priority Data
May 14, 2025 (JP) 2025-081428

(51) Int. Cl. H01M 4/04; F26B 3/04; F26B 15/12; F26B 21/00

(52) U.S. Cl. CPC H01M 4/04; F26B 3/04; F26B 15/122; F26B 21/001

(57) ABSTRACT

A method of manufacturing a strip-shaped electrode plate including a plurality of strips of active material layers with protective layers arranged in a width direction includes a drying process of drying undried active material layers with protective layers while conveying in a conveying direction an undried strip-shaped electrode plate having a plurality of strips of undried active material layers with protective layers each comprising an undried active material layer and undried first and second protective layers on a current collecting foil. In the drying process, flowing hot air in the width direction over the undried first protective layer, the undried active material layer, and the undried second protective layer, in this order, to dry these layers, and flowing hot air in the opposite direction to dry these layers are performed alternately in the conveying direction, for each strip of the undried active material layers with protective layers.

### CROSS-REFERENCE TO RELATED APPLICATIONS

This application is based upon and claims the benefit of priority to Japanese Patent Application No. 2025-081428 filed on May 14, 2025, the entire contents of which are incorporated herein by reference.

### BACKGROUND

### Technical Field

The disclosure relates to a method of manufacturing a strip-shaped electrode plate having a plurality of strips of active material layers with protective layers on a strip-shaped current collecting foil, and a drying apparatus used for the manufacture of the strip-shaped electrode plate.

### Related Art

Japanese unexamined patent application publication No. 2021-174619 (JP 2021-174619 A) discloses a method of manufacturing a strip-shaped electrode plate having strip-shaped active material layers and strip-shaped protective layers on a strip-shaped current collecting foil. Specifically, a method of drying undried active material layers and protective layers applied onto the current collecting foil, using hot air, is disclosed. More specifically, while conveying the current collecting foil in the longitudinal direction, hot air is delivered to flow in the longitudinal direction in the drying process to dry an undried active material layer with protective layers having an undried active material layer of an undried strip-shaped electrode plate and undried first and second protective layers containing a higher proportion of dispersion medium than the undried active material layer.

### SUMMARY

### Technical Problems

However, when the hot air flowing in the longitudinal direction is viewed in the width direction, a portion of the hot air flowing in the longitudinal direction while drying the undried first and second protective layers contains a larger amount of dispersion medium as it proceeds than a portion of the hot air flowing in the longitudinal direction while drying the undried active material layer. Therefore, the undried first and second protective layers are more difficult to dry than the undried active material layer. Accordingly, in order to sufficiently dry the undried first and second protective layers, the drying apparatus needs to be longer, and the drying process takes a lot of time.

Thus, the inventor proposed a method and a drying apparatus for drying an undried active material layer with protective layers provided on a strip-shaped current collecting foil by flowing hot air in a width direction perpendicular to the conveying direction (the longitudinal direction). Furthermore, in order to prevent uneven drying across the width, hot air flowing to one side in the width direction and hot air flowing to the other side in the width direction are fed alternately in the conveying direction to the protective layers and the active material layer to dry these layers at the same time, consequently, in a short time.

In some cases, multiple strips of undried active material layers with protective layers each comprising an undried active material layer and a pair of undried protective layers are formed on a strip-shaped current collecting foil having a large width to provide an undried strip-shaped electrode plate, which is then dried to form a strip-shaped electrode plate. In this case, too, it may be considered to dry the undried strip-shaped electrode plate with the multiple strips by flowing the hot air to the one side in the width direction and the hot air to the other side in the width direction alternately in the conveying direction, over the entire width of the strip-shaped electrode foil, in the manner similar to the above.

However, this may result in uneven drying between the inner and outer portions in the width direction of the multiple strips of undried active material layers with protective layers. For example, the inner portion in the width direction is less likely to be dried.

The disclosure was developed in view of the above situation, and provides a manufacturing method for a strip-shaped electrode plate and a drying apparatus, with which the strip-shaped electrode plate is formed by drying an undried strip-shaped electrode plate having multiple strips of undried active material layers with protective layers each comprising an undried active material layer and a pair of undried protective layers formed on a strip-shaped current collecting foil, such that each strip of undried active material layer with protective layers can be appropriately dried and formed.

### Means of Solving the Problems

(1) One aspect of the disclosure for solving the above problem is a method of manufacturing a strip-shaped electrode plate including a strip-shaped current collecting foil extending in a longitudinal direction and a plurality of strips of active material layers with protective layers on a surface of the strip-shaped current collecting foil. Each of the active material layers with protective layers comprises an active material layer extending in the longitudinal direction, a first protective layer provided on one side in a width direction of the active material layer and extending in the longitudinal direction, and a second protective layer provided on the other side in the width direction of the active material layer and extending in the longitudinal direction. The active material layers with protective layers are arranged in the width direction via foil exposed portions where the strip-shaped current collecting foil is exposed in the shape of strips extending in the longitudinal direction. The method includes a drying process of drying a plurality of strips of undried active material layers with protective layers while conveying an undried strip-shaped electrode plate having the strip-shaped current collecting foil and the strips of undried active material layers with protective layers provided on the strip-shaped current collecting foil, in a conveying direction aligned with the longitudinal direction. Each of the undried active material layers with protective layers comprises an undried active material layer that becomes the active material layer when dried, and an undried first protective layer and an undried second protective layer that contain a higher proportion of a dispersion medium than the undried active material layer and become the first protective layer and the second protective layer when dried. In the drying process, for each of the strips of undried active material layers with protective layers, an each-strip one-side hot air drying process of flowing one-side hot air over the undried first protective layer, the undried active material layer, and the undried second protective layer, in the order of description, to dry the undried first protective layer, the undried active material layer, and the undried second protective layer, and an each-strip other-side hot air drying process of flowing other-side hot air over the undried second protective layer, the undried active material layer, and the undried first protective layer, in the order of description, to dry the undried second protective layer, the undried active material layer, and the undried first protective layer, are alternately performed in the conveying direction.

In the above method of manufacturing the strip-shaped electrode plate, in the drying process, the each-strip one-side hot air drying process of flowing one-side hot air in the width direction and the each-strip other-side hot air drying process of flowing the other-side hot air in the width direction are performed alternately in the conveying direction, for each strip of the undried active material layers with protective layers. Therefore, in the formation of multiple strips of active material layers with protective layers, each strip of undried active material layer with protective layers can be reliably dried in a short time.

When respective strips of undried active material layers with protective layers are viewed individually, the position in the conveying direction where the each-strip one-side hot air drying process and the each-strip other-side hot air drying process are switched can be determined for each strip of the undried active material layers with protective layers. That is, the switching position between the each-strip one-side hot air drying process and the each-strip other-side hot air drying process may differ for each strip of undried active material layer with protective layers. Conversely, the switching position may be set to the same position between the undried active material layers with protective layers.
(2) In the method of manufacturing the strip-shaped electrode plate described in (1) above, the each-strip one-side hot air drying process and the each-strip other-side hot air drying process may be switched at the same switching positions along the conveying direction with respect to any of the strips of undried active material layers with protective layers.
(3) In the method of manufacturing the strip-shaped electrode plate described in (1) or (2) above, the each-strip one-side hot air drying process and the each-strip other-side hot air drying process may be continuously performed for the undried active material layers with protective layers conveyed in the conveying direction, while separating the one-side hot air and the other-side hot air adjacent to each other in the conveying direction and flowing in opposite directions by use of a hot air separator.
(4) In the method of manufacturing the strip-shaped electrode plate described in (3) above, the hot air separator may be provided at the same position in the conveying direction with respect to each of the strips of undried active material layers with protective layers.
(5) Another aspect of the disclosure for solving the above problem is a drying apparatus for drying an undried strip-shaped electrode plate including a strip-shaped current collecting foil extending in a longitudinal direction and a plurality of strips of undried active material layers with protective layers on a surface of the strip-shaped current collecting foil. Each of the undried active material layers with protective layers comprises an undried active material layer extending in the longitudinal direction, an undried first protective layer located on one side in a width direction of the undried active material layer and extending in the longitudinal direction, and an undried second protective layer located on the other side in the width direction of the undried active material layer and extending in the longitudinal direction. The undried active material layers with protective layers are arranged in the width direction via foil exposed portions where the strip-shaped current collecting foil is exposed in the shape of strips extending in the longitudinal direction. The drying apparatus includes a conveying unit that conveys the undried strip-shaped electrode plate with the undried active material layers with protective layers facing upward, in a conveying direction aligned with the longitudinal direction, and an each-strip one-side hot air drying unit and an each-strip other-side hot air drying unit alternately arranged in the conveying direction, for each of the strips of undried active material layers with protective layers. The each-strip one-side hot air drying unit flows one-side hot air the undried first protective layer, the undried active material layer, and the undried second protective layer, in the order of description, to dry the undried first protective layer, the undried active material layer, and the undried second protective layer, and the each-strip other-side hot air drying unit flows other-side hot air over the undried second protective layer, the undried active material layer, and the undried first protective layer, in the order of description, to dry the undried second protective layer, the undried active material layer, and the undried first protective layer.

In the drying apparatus, the one-side hot air drying unit and the other-side hot air drying unit are arranged alternately in the conveying direction for each strip of the undried active material layers with protective layers. Thus, in the formation of multiple strips of active material layers with protective layers, each strip of the undried active material layers with protective layers can be reliably dried in a short time.
(6) In the drying apparatus described in (5) above, the each-strip one-side hot air drying unit and the each-strip other-side hot air drying unit may be switched at the same switching positions along the conveying direction with respect to any of the strips of undried active material layers with protective layers.
(7) The drying apparatus described in (5) or (6) above may further include a hot air separator provided between the each-strip one-side hot air drying unit and the each-strip other-side hot air drying unit for separating the one-side hot air and the other-side hot air adjacent to each other in the conveying direction and flowing in opposite directions.
(8) In the drying apparatus described in (7) above, the hot air separator may be provided at the same position in the conveying direction with respect to each of the strips of undried active material layers with protective layers.

### BRIEF DESCRIPTION OF THE DRAWINGS

FIG. 1 is an explanatory view of a strip-shaped electrode plate according to an embodiment and a modified embodiment;

FIG. 2 is a flowchart showing each step of the manufacture of the strip-shaped electrode plate according to the embodiment;

FIG. 3 is an explanatory view schematically showing each step of the manufacture of the strip-shaped electrode plate according to the embodiment and the modified embodiment;

FIG. 4 is an explanatory view of a drying apparatus for drying the strip-shaped electrode plate, as seen in the direction of arrows A-A in FIG. 5 from the downstream side in the conveying direction, according to the embodiment;

FIG. 5 is an explanatory view of the drying apparatus for drying the strip-shaped electrode plate, as seen from above, according to the embodiment;

FIG. 6 is an explanatory view of the drying apparatus for drying the strip-shaped electrode plate, as seen in the direction of arrows B-B in FIG. 5 from the width direction, according to the embodiment and the modified embodiment;

FIG. 7 is a flowchart showing each step of the manufacture of the strip-shaped electrode plate according to the modified embodiment;

FIG. 8 is an explanatory view of a drying apparatus for drying the strip-shaped electrode plate, as seen in the direction of arrows A-A in FIG. 9 from the downstream side in the conveying direction, according to the modified embodiment; and

FIG. 9 is an explanatory view of the drying apparatus for drying the strip-shaped electrode plate as seen from above, according to the modified embodiment.

### DETAILED DESCRIPTION OF THE EXEMPLARY EMBODIMENTS

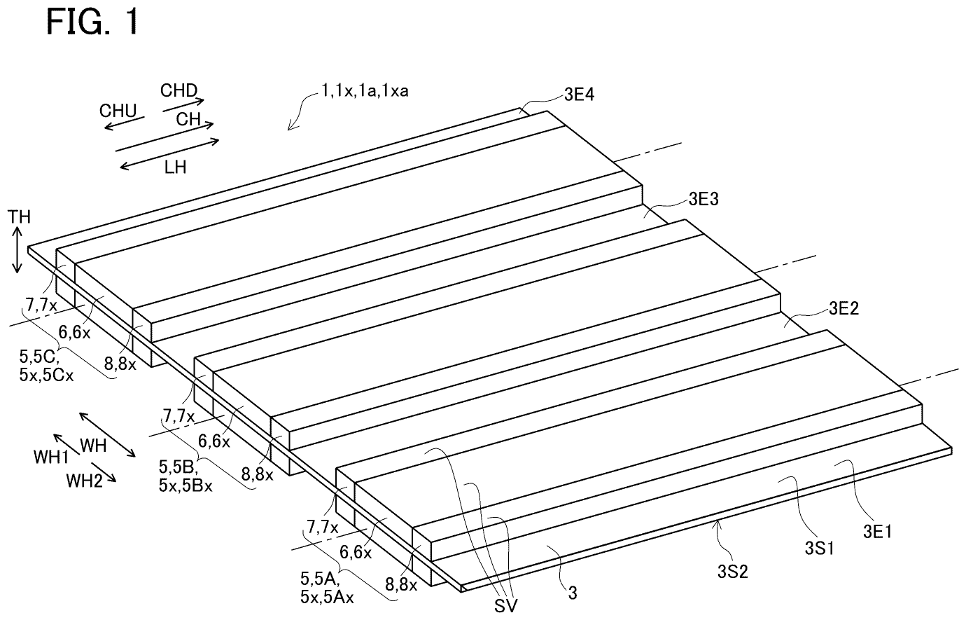

The manufacture of a strip-shaped electrode plate 1 according to one embodiment of the disclosure and a manufacturing apparatus 100 for the strip-shaped electrode plate 1 will be described with reference to the drawings. The strip-shaped electrode plate 1 having a large width as shown in FIG. 1 is used to manufacture rectangular, sealed lithium-ion secondary batteries installed on vehicles, such as HVs, PHEVs, and BEVs, and various other devices. Specifically, the strip-shaped electrode plate 1 is a strip-shaped positive electrode plate used to manufacture flat wound type or laminate type electrode bodies that constitute batteries.

The strip-shaped electrode plate 1 of this embodiment comprises a large-width strip-shaped current collecting foil 3 extending in a longitudinal direction LH and made of aluminum, and three strips of strip-shaped active material layers 5 with protective layers, which are hereinafter also referred to as composite active material layers 5, extending in the longitudinal direction LH and provided on each of a first surface 3S1 and a second surface 3S2 on both sides of the strip-shaped current collecting foil 3. The three strips of composite active material layers 5 will be referred to as the first-strip to third-strip active material layers 5A, 5B, 5C with protective layers, which are hereinafter also referred to as composite active material layers 5A, 5B, and 5C.

Each of the three strips of composite active material layers 5 comprises a strip-shaped active material layer 6 extending in the longitudinal direction LH and strip-shaped first protective layer 7 and second protective layer 8 also extending in the longitudinal direction LH. The strip-shaped current collecting foil 3 includes strip-shaped foil exposed portions 3E1 to 3E4 where the strip-shaped current collecting foil 3 is exposed. The foil exposed portions 3E1 to 3E4 comprise opposite edge portions of the strip-shaped current collecting foil 3 as viewed in the width direction WH perpendicular to the longitudinal direction LH and portions between the composite active material layers 5. The first protective layer 7 is provided on one side WH1 in the width direction WH of the active material layer 6, and extends along the active material layer 6. On the other hand, the second protective layer 8 is provided on the other side WH2 in the width direction WH of the active material layer 6 opposite to the first protective layer 7, and extends along the active material layer 6.

The active material layer 6 contains lithium transition metal composite oxide particles as active material particles, acetylene black as conductive particles, and polyvinylidene fluoride (PVDF) as a binder. The first protective layer 7 and the second protective layer 8 contain alumina particles as insulating ceramic particles and PVDF as a binder.

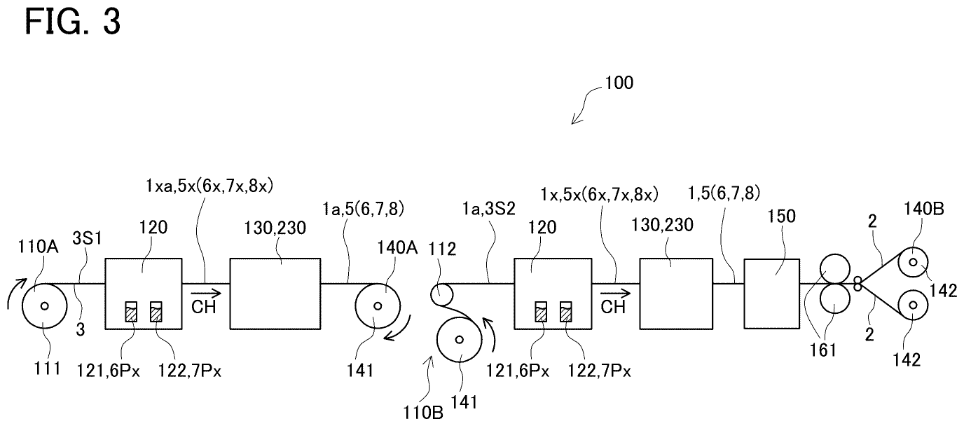

The active material layer 6 of the composite active material layer 5is formed by drying an undried active material layer 6x formed by applying an active material paste 6Px onto the strip-shaped current collecting foil 3 (see FIG. 3). The active material paste 6Px is obtained by dispersing the active material particles, conductive particles, and the binder in N-methylpyrrolidone (NMP) as a dispersion medium SV. In this embodiment, the solid content of the active material paste 6Px is adjusted to approximately 55% to 60%.

On the other hand, the first protective layer 7 and the second protective layer 8 are formed by drying an undried first protective layer 7x and an undried second protective layer 8x, respectively, which are formed by applying a protective paste 7Px onto the strip-shaped current collector foil 3 (see FIG. 3). The protective paste 7Px is obtained by dispersing the insulating ceramic particles and the binder in NMP as a dispersion medium SV. The solid content of the protective paste 7Px is approximately 25 to 30 wt. %. That is, compared to the active material paste 6Px, the proportion of the dispersion medium SV contained in the protective paste 7Px is higher, and compared to the undried active material layer 6x, the undried first protective layer 7x and the undried second protective layer 8x contain a greater amount of dispersion medium SV per unit volume.

Therefore, in undried active material layer 5x with protective layers, which are hereinafter also referred to as undried composite active material layer 5x, the undried first protective layer 7x and the undried second protective layer 8x are more difficult to dry than the undried active material layer 6x. Moreover, the protective paste 7Px using alumina particles for use in this embodiment, and the undried first protective layer 7x and undried second protective layer 8x formed by applying it, are light white in color and are less likely to absorb infrared rays. From this point, too, the undried first protective layer 7x and the undried second protective layer 8x are less likely to be heated and less likely to be dried than the undried active material layer 6x.

Therefore, when drying the undried composite active material layer 5x, if hot air is directed toward the downstream side CHD or upstream side CHU in the conveying direction CH aligned with the longitudinal direction LH, as in a conventional method, to dry the undried first protective layer 7x and the undried second protective layer 8x in parallel with drying of the undried active material layer 6x, the undried first protective layer 7x and the undried second protective layer 8x are more likely to be brought into an insufficiently dried state than the undried active material layer 6x. Part of the hot air that flows over the undried first protective layer 7x or the undried second protective layer 8x contains a larger amount of evaporated dispersion medium SV than the hot air flowing over the undried active material layer 6x. Consequently, the temperature of that part of hot air decreases, and the vapor pressure of the dispersion medium SV increases, making it increasingly difficult to dry the undried first protective layer 7x and the undried second protective layer 8x as the hot air progresses downstream or upstream.

Thus, in this embodiment, the three strips of undried composite active material layers 5x (the undried active material layers 6x, the undried first protective layers 7x, and the undried second protective layers 8x) formed on the strip-shaped current collecting foil 3 are respectively dried by feeding hot air alternately toward one side WH1 and the other side WH2 in the width direction WH perpendicular to the longitudinal direction LH, unlike the conventional method.

However, if the hot air is fed to proceed toward one side WH1 or the other side WH2 over the entire width of the strip-shaped current collecting foil 3 in the width direction WH, that is, if the hot air is fed to proceed across the three strips of undried active material layers 5x (5Ax, 5Bx, 5Cx) with protective layers to dry these layers 5x, a portion located inside in the width direction WH, for example, the undried active material layer 5Bx with protective layers, of the three undried active material layers 5x with protective layers becomes more difficult to dry than the others, making it difficult to achieve uniform drying in the width direction WH.

Thus, in this embodiment, the hot air is fed to proceed alternately toward one side WH1 and the other side WH2 in the width direction WH, for each of the three undried active material layers 5Ax, 5Bx, 5Cx with protective layers formed on the strip-shaped current collecting foil 3, to dry these layers, as described below.

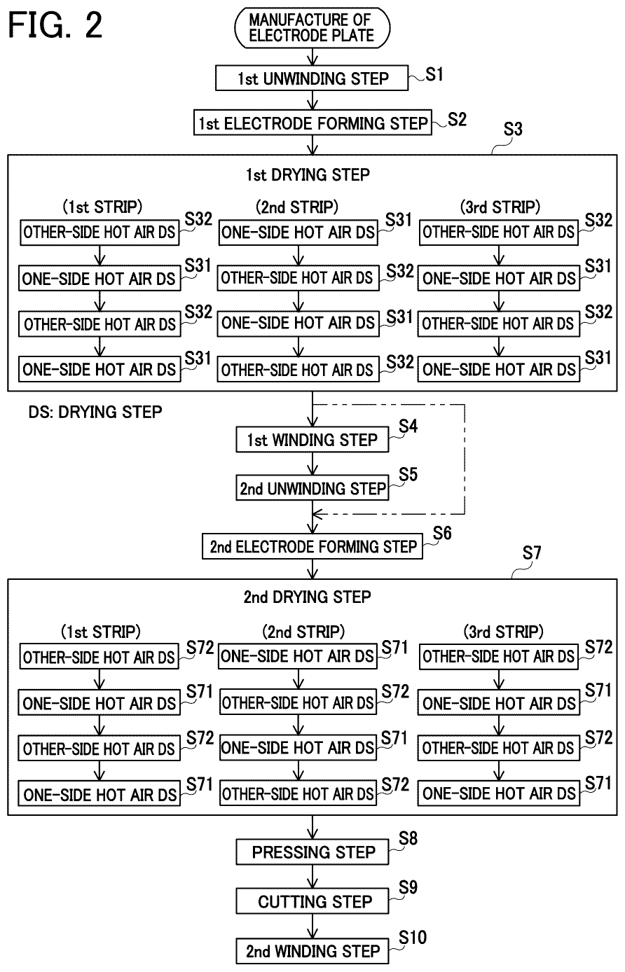

First, the method of manufacturing the strip-shaped electrode plates 1a, 1 and divided electrode plates 2 using the manufacturing apparatus 100 will be schematically described with reference to FIG. 2 and FIG. 3. In a first unwinding step S1, the strip-shaped current collecting foil 3 wound on a reel 111 is unwound by an unwinding device 110A and fed into a coating device 120 with its first surface 3S1 facing upward as a surface to be coated.

In a first electrode forming step S2, the three strips of undried composite active material layers 5x (5Ax, 5Bx, 5Cx) are provided on the first surface 3S1 of the strip-shaped current collecting foil 3 while being spaced from each other, to form an undried strip-shaped electrode plate 1xa. Specifically, in the coating device 120, the active material paste 6Px contained in a first tank 121 and the protective paste 7Px contained in a second tank 122 are used to form three strips of undried composite active material layers 5x, each consisting of the undried active material layer 6x, the undried first protective layer 7x, and the undried second protective layer 8x, on the first surface 3S1 of the strip-shaped current collecting foil 3 such that the undried composite active material layers 5x are spaced from each other. As described above, the undried active material layer 6x becomes the active material layer 6 after drying. Also, the undried first protective layer 7x and the undried second protective layer 8x become the first protective layer 7 and the second protective layer 8 after drying. Also, the undried composite active material layers 5x (5Ax, 5Bx, 5Cx) become the composite active material layers 5 (5A, 5B, 5C) after drying.

In this embodiment, the coating device 120 is specifically a die coater, which simultaneously and continuously discharges and applies the active material paste 6Px and the protective paste 7Px onto the first surface 3S1 of the strip-shaped current collecting foil 3 conveyed in the longitudinal direction LH, to simultaneously form the strip-shaped undried active material layers 6x, and the undried first protective layers 7x and the undried second protective layers 8x along the undried active material layers 6x. The strip-shaped foil exposed portions 3E1 to 3E4 where the strip-shaped current collecting foil 3 is exposed are left at opposite end portions of the strip-shaped current collecting foil 3 and between the undried composite active material layers 5x. As described above, in the undried composite active material layer 5x, the amount of the dispersion medium SV contained per unit volume in the undried first protective layer 7x and the undried second protective layer 8x is larger than that in the undried active material layer 6x.

Next, in a first drying step S3, the three strips of undried composite active material layers 5Ax, 5Bx, 5Cx formed on the undried strip-shaped electrode plate 1xa are respectively dried, using a drying apparatus 130 that will be described below in detail, to form the strip-shaped electrode plate 1a having the three strips of composite active material layers 5A, 5B, 5C. Specifically, the undried active material layers 6x, the undried first protective layers 7x, and the undried second protective layers 8x that form the undried composite active material layers 5Ax, 5Bx, 5Cx are dried, to form the active material layers 6, the first protective layers 7, and the second protective layers 8.

Subsequently, in a first winding step S4, a winding device 140A once winds the strip-shaped electrode plate 1a onto a reel 141. Then, in a second unwinding step S5, an unwinding device 110B is used to unwind the strip-shaped electrode plate 1a on the reel 141. Furthermore, the strip-shaped current collecting foil 3 is inverted using an inverting roll 112 so that the second surface 3S2 becomes a surface to be coated, and is fed into a coating device 120 similar to the one described above.

As indicated by a two-dot chain line in FIG. 2, the first winding step S4 and the second unwinding step S5 may be omitted. Instead, the strip-shaped electrode plate 1a formed in the first drying step S3 may be inverted vertically and fed into the coating device 120 of a second electrode forming step S6 that will be described next.

In the second electrode forming step S6, in the coating device 120, the active material paste 6Px and the protective paste 7Px are continuously applied to the second surface 3S2 of the strip-shaped current collecting foil 3 of the strip-shaped electrode plate 1a conveyed in the conveying direction CH, to form three strips of undried composite active material layers 5x, each consisting of the strip-shaped undried active material layer 6x, the undried first protective layer 7x, and the undried second protective layer 8x, such that the three undried composite active material layers 5x are spaced from each other.

Then, in a second drying step S7, too, the three strips of undried composite active material layers 5Ax, 5Bx, 5Cx formed on the undried strip-shaped electrode plate 1x are respectively dried, using the drying apparatus 130 that will be described below in detail, to form the strip-shaped electrode plate 1 having the composite active material layers 5A, 5B, 5C. Specifically, the undried active material layers 6x, the undried first protective layers 7x, and the undried second protective layers 8x, which form the undried composite active material layers 5Ax, 5Bx, 5Cx on the undried strip-shaped electrode plate 1x, are dried. Thus, the strip-shaped electrode plate 1 having on the first surface 3S1 and second surface 3S2, respectively, three strips of composite active material layers 5A, 5B, 5C, each consisting of the active material layer 6, the first protective layer 7, and the second protective layer 8, is formed.

Subsequently, in a pressing step S8, a press device 150 (specifically, a roll press) is used to roll-press the above strip-shaped electrode plate 1 in the thickness direction TH while conveying it in the longitudinal direction LH, thereby increasing the density of the active material layers 6 and completing the strip-shaped electrode plate 1.

In addition, in a cutting step S9, the strip-shaped electrode plate 1 (see FIG. 1) is cut into six segments in the width direction WH using a cutting blade 161 to form divided electrode plates 2. In the following second winding step S10, the divided electrode plates 2 are each wound onto a reel 142 using a winding device 140B.

Next, the first drying step S3 and the second drying step S7, and the drying apparatus 130 used in these steps will be described with reference to FIG. 2 and FIG. 4 to FIG. 6. Description of the second drying step S7, one-side hot air drying step S71, and the other-side hot air drying step S72, which are substantially the same as the first drying step S3, one-side hot air drying step S31, and the other-side hot air drying step S32, will be omitted or simplified, and the first drying step S3, etc. will be mainly described.

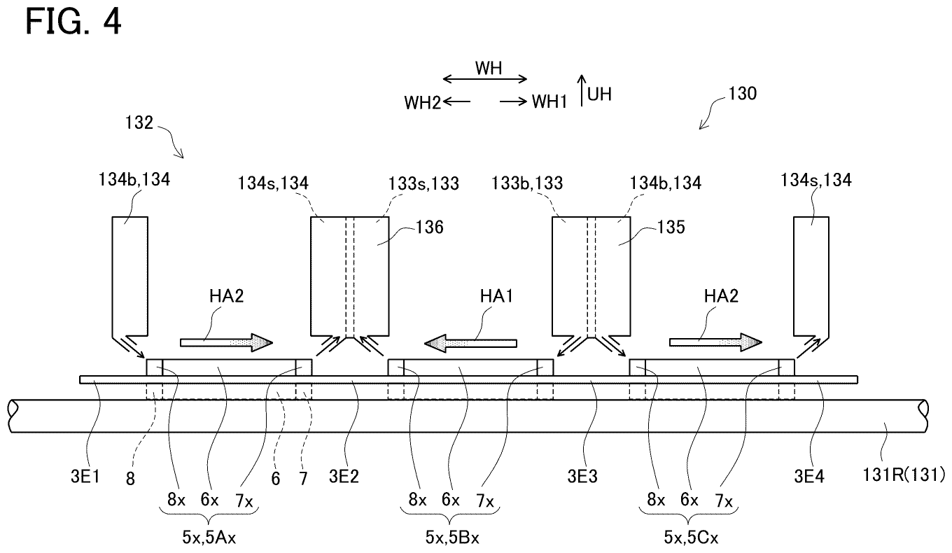

In the first drying step S3 and the second drying step S7, the undried strip-shaped electrode plate 1xa, 1x is dried by the drying apparatus 130 shown in FIG. 4 to FIG. 6. The drying apparatus 130 comprises a conveying section 131 that consists of a plurality of conveying rolls 31R that convey the undried strip-shaped electrode plate 1xa, 1x in the conveying direction CH aligned with the longitudinal direction LH, and a drying section 132 that dries the undried strip-shaped electrode plate 1xa, 1x with hot air.

In the first drying step S3 and the second drying step S7, as described above, the three strips of undried composite active material layers 5Ax, 5Bx, 5Cx formed on the undried strip-shaped electrode plate 1xa are dried respectively to form the strip-shaped electrode plate 1a having the three strips of composite active material layers 5A, 5B, 5C. As described above, hot air is fed to proceed alternately toward one side WH1 and the other side WH2 in the width direction WH for each of the three undried composite active material layers 5Ax, 5Bx, 5Cx to dry these layers. That is, in this embodiment, a total of four hot air drying steps, i.e., two one-side hot air drying steps S31 and two other-side hot air drying steps S32, are alternately performed for each strip of the undried composite active material layers 5Ax, 5Bx, 5Cx. The second drying step S7 is performed similarly.

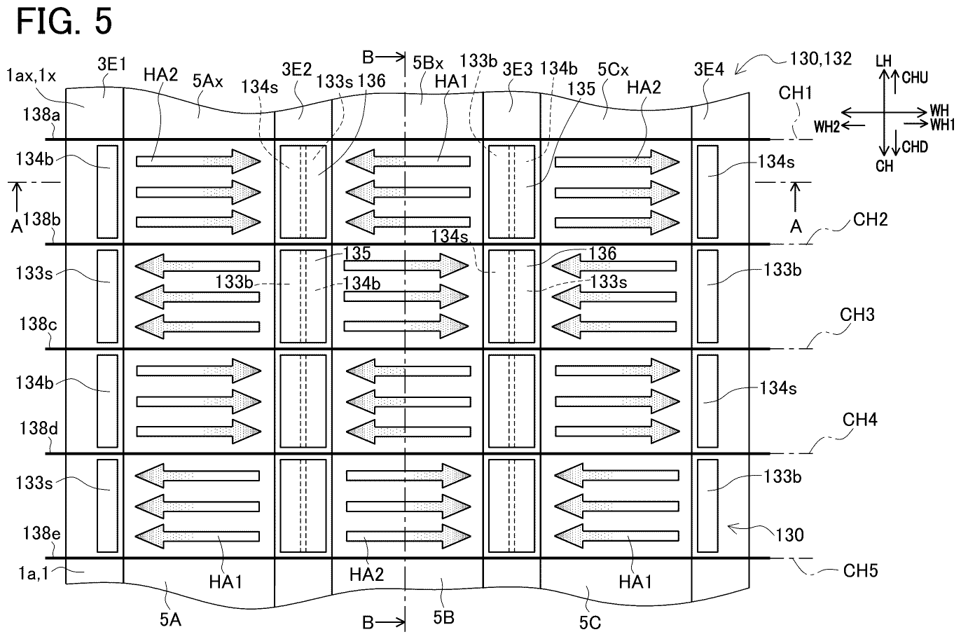

In the one-side hot air drying step S31, S71, a one-side hot air drying unit 133 is used to cause one-side hot air HA1 flowing from one side WH1 to the other side WH2 (leftward in FIG. 4 and FIG. 5) in the width direction WH to flow over the undried first protective layer 7x, the undried active material layer 6x, and the undried second protective layer 8x of one strip of undried composite active material layer 5x, in this order, to dry these layers. In the other-side hot air drying step S32, S72, an other-side hot air drying unit 134 is used to cause other-side hot air HA2 flowing from the other side WH2 to the one side WH1 (rightward in FIG. 4 and FIG. 5) in the width direction WH to flow over the undried second protective layer 8x, the undried active material layer 6x, and the undried first protective layer 7x of one strip of undried composite active material layer 5x, in this order, to dry these layers. Therefore, in the drying apparatus 130, a total of four stages of the one-side hot air drying units 133 and the other-side hot air drying units 134 are alternately arranged in the conveying direction CH with respect to each of the three strips of undried composite active material layers 5Ax, 5Bx, 5Cx, as shown in FIG. 4 to FIG. 6. Then, the four stages of one-side hot air drying units 133 and the other-side hot air drying units 134 are arranged in three columns in the width direction WH. Consequently, in the formation of multiple strips (three strips in this embodiment) of composite active material layers 5, each strip of undried composite active material layer 5x can be reliably dried in a short time.

In this connection, the position in the conveying direction CH where the one-side hot air drying step S31, S71 and the other-side hot air drying step S32, S72 performed for each undried composite active material layer 5Ax, 5Bx, 5Cx are switched, namely, the position in the conveying direction CH where the one-side hot air drying unit 133 and the other-side hot air drying unit 134 are switched can be selected as appropriate. In this embodiment, for any of the three strips of undried composite active material layers 5Ax, 5Bx, 5Cx, the one-side hot air drying step S31, S71 and the other-side hot air drying step S32, S72 (the one-side hot air drying unit 133 and the other-side hot air drying unit 134) are switched at the same positions in the conveying direction CH. Specifically, the one-side hot air drying step S31 and the other-side hot air drying step S32 (the one-side hot air drying unit 133 and the other-side hot air drying unit 134) are switched at the second to fourth positions CH2 to CH4 in the conveying direction CH (see FIG. 4 and FIG. 5). That is, the one-side hot air drying units 133 and the other-side hot air drying units 134, which are arranged in four stages in the conveying direction, are switched at the same second to fourth positions CH2 to CH4 in the conveying direction CH with respect to any of the three strips of undried composite active material layers 5Ax, 5Bx, 5Cx. In this way, since the second to fourth positions CH2 to CH4 are respectively aligned for the three strips of undried composite active material layers 5Ax, 5Bx, 5Cx, it is easy to ensure uniform drying conditions for each strip.

Furthermore, in the first drying step S3 and second drying step S7 of this embodiment, and in the drying apparatus 130 used in these steps, the direction of hot air flow is made different between the undried composite active material layers 5x adjacent to each other in the width direction WH. That is, as shown in FIG. 4 and FIG. 5, when the one-side hot air drying step S31, S 71 is performed using the one-side hot air drying unit 133 to flow the one-side hot air HA1 over the undried composite active material layer 5Bx located at the center (the second strip) in the width direction WH among the three undried composite active material layers 5x, for example, the other-side hot air drying steps S32, S72 are performed using the other-side hot air drying units 134 to flow the other-side hot air HA2 over the undried composite active material layers 5Ax, 5Cx, which are adjacent to the undried composite active material layer 5Bx on both outer sides (the first and third strips) in the width direction WH. Conversely, when the other-side hot air drying step S32, S72 is performed using the other-side hot air drying unit 134 to flow the other-side hot air HA2 over the undried composite active material layer 5Bx with protective layers, the one-side hot air drying steps S31, S71 are performed using the one-side hot air drying units 133 to flow the one-side hot air HA1 over the undried composite active material layers 5Ax, 5Cx, which are adjacent to the undried composite active material layer 5Bx on both sides.

That is, for the undried composite active material layer 5Bx at the center in the width direction WH, the hot air drying steps are performed in the order of the one-side hot air drying step S31, the other-side hot air drying step S32, the one-side hot air drying step S31, and the other-side hot air drying step S32 (see FIG. 2). For this purpose, in the drying apparatus 130, the hot air drying units for drying the undried composite active material layer 5Bx are arranged toward the downstream side CHD in the conveying direction CH, in the order of the one-side hot air drying unit 133, the other-side hot air drying unit 134, the one-side hot air drying unit 133, and the other-side hot air drying unit 134 (see FIG. 5). On the other hand, for the undried composite active material layers 5Ax, 5Cx, the hot air drying steps are performed in the order of the other-side hot air drying step S32, the one-side hot air drying step S31, the other-side hot air drying step S32, and the one-side hot air drying step S31. For this purpose, in the drying apparatus 130, the hot air drying units for drying the undried composite active material layers 5Ax, 5Cx are arranged toward the downstream side CHD in the conveying direction CH, in the order of the other-side hot air drying unit 134, the one-side hot air drying unit 133, the other-side hot air drying unit 134, and the one-side hot air drying unit 133. The same applies to the one-side hot air drying step S71 and the other-side hot air drying step S72.

The one-side hot air drying unit 133 comprises a pair consisting of a hot air delivery section 133b and a hot air suction section 133s. The one-side hot air drying unit 133 flows one-side hot air HA1 sequentially over the undried first protective layer 7x, the undried active material layer 6x, and the undried second protective layer 8x, which form the undried composite active material layer 5x to be dried, to dry these layers. The hot air delivery section 133b is positioned on the one side WH1 (the right-hand side in FIG. 4 and FIG. 5) relative to the undried composite active material layer 5x to be dried, in the width direction WH perpendicular to the longitudinal direction LH, and delivers the one-side hot air HA1 from the one side WH1 (the right-side in FIG. 4 and FIG. 5) to the other side WH2 (leftward in FIG. 4 and FIG. 5). The hot air suction section 133s is positioned on the other side WH2 (the left-hand side in FIG. 4 and FIG. 5) relative to the hot air delivery section 133b and sucks in the one-side hot air HA1 that has flowed to the other side WH2 over the undried composite active material layer 5x.

In contrast, the other-side hot air drying unit 134 comprises a pair consisting of a hot air delivery section 134b and a hot air suction section 134s. The other-side hot air drying unit 134 flows other-side hot air HA2 sequentially over the undried second protective layer 8x, the undried active material layer 6x, and the undried first protective layer 7x, which form the undried composite active material layer 5x to be dried, to dry these layers. Of the other-side hot air drying unit 134, the hot air delivery section 134b is positioned on other side WH2 relative to the undried composite active material layer 5x to be dried, and delivers the other-side hot air HA2 from the other side WH2 to the one side WH1. The hot air suction section 134s is positioned on the one side WH1 relative to the hot air delivery section 134b and sucks in the other-side hot air HA2 that has flowed to the one side WH1 over the undried composite active material layer 5x.

In the above manner, the one-side hot air drying unit 133 or the other-side hot air drying unit 134 comprising the hot air delivery section 133b,134b and the hot air suction section 133s, 134s is used to suck in the blown one-side hot air HA1 or other-side hot air HA2. Thus, while suppressing the effects of the one-side hot air HA1 or the other-side hot air HA2 on the surroundings, a large number of sets (twelve sets in this embodiment) of the one-side hot air drying units 133 and the other-side hot air drying units 134 can be arranged in the drying section 132 of the drying apparatus 130. Thus, the drying apparatus 130 can be made compact.

The hot air delivery sections 133b, 134b and the hot air suction sections 133s, 134s forming the one-side hot air drying units 133 and the other-side hot air drying units 134 are preferably provided on the upper side UH of the foil exposed portions 3E1 to 3E4, respectively, as shown in FIG. 4 and FIG. 5. One example will be described with regard to the second strip of undried composite active material layer 5Bx. The hot air delivery section 133b is placed above the foil exposed portion 3E3 located on the one side WH1 of the undried composite active material layer 5Bx. Meanwhile, the hot air suction section 133s is placed above the foil exposed portion 3E2 located on the other side WH2 of the undried composite active material layer 5Bx. Furthermore, the hot air delivery section 134b is placed above the foil exposed portion 3E2 located on the other side WH2 of the undried composite active material layer 5Bx, while the hot air suction section 134s is placed above the foil exposed portion 3E3 located on the one side WH1 of the undried composite active material layer 5Bx. With this arrangement, it is possible to flow the one-side hot air HA1 or the other-side hot air HA2 over the undried composite active material layer 5Bx, without affecting drying of the undried composite active material layers 5Ax, 5Cx adjacent to the undried composite active material layer 5Bx in the width direction WH, and the undried composite active material layer 5Bx can be dried over the entire length in the width direction WH.

Furthermore, in the drying apparatus 130 of this embodiment, the one-side hot air drying unit 133 and the other-side hot air drying unit 134 are arranged alternately in the width direction WH. Therefore, as indicated by dashed lines in FIG. 4 and FIG. 5, the hot air delivery section 133b of the one-side hot air drying unit 133 and the hot air delivery section 134b of the other-side hot air drying unit 134 are positioned adjacent to each other over the same foil exposed portion. Furthermore, the hot air suction section 133s of the one-side hot air drying unit 133 and the hot air suction section 134s of the other-side hot air drying unit 134 are also positioned adjacent to each other over the same foil exposed portion. Therefore, instead of these sections, a combined hot air delivery section 135, which serves both as the hot air delivery section 133b and the hot air delivery section 134b, and a combined hot air suction section 136, which serves both as the hot air suction section 133s and the hot air suction section 134s, may be provided as indicated by solid lines in FIG. 4 and FIG. 5. This configuration offers the advantage of facilitating the supply of hot air to the hot air delivery section 133b and the hot air delivery section 134b and the discharge of hot air from the hot air suction section 133s and the hot air suction section 134s.

As shown in FIG. 5, the one-side hot air HA1 and the other-side hot air HA2 flow contiguously in the opposite directions in the one-side hot air drying unit 133 and the other-side hot air drying unit 134 adjacent to it in the conveying direction CH. Therefore, near the second to fourth positions CH2 to CH4, which are the switching positions in the conveying direction CH between the one-side hot air drying unit 133 and the other-side hot air drying unit 134 adjacent to it in the conveying direction CH, the one-side hot air HA1 and the other-side hot air HA2 flowing in the opposite directions may collide with each other and generate turbulence, potentially causing problems such as uneven drying in this area.

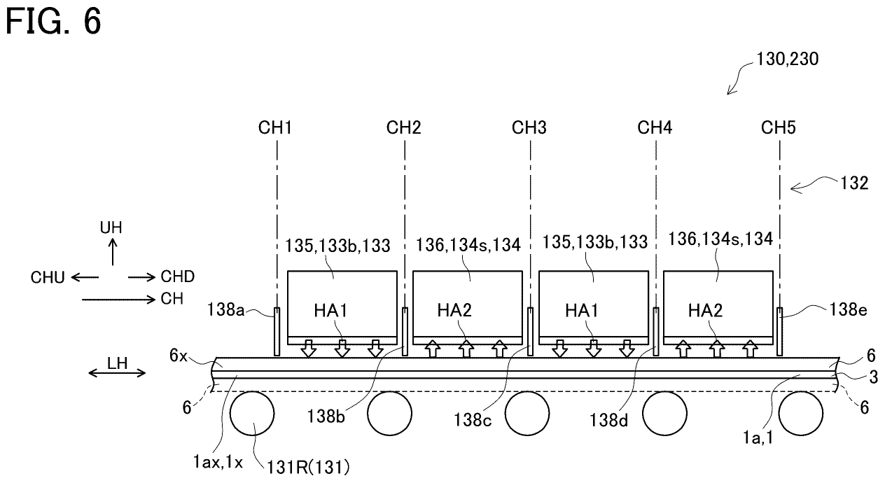

Therefore, in this embodiment, plate-shaped hot air separators 138b to 138d that separate the one-side hot air HA1 from the other-side hot air HA2 are respectively provided between the one-side hot air drying units 133 and the adjacent other-side hot air drying units 134, specifically, at the second to fourth positions CH2 to CH4 as the switching positions along the conveying direction CH. In addition, in this embodiment, a hot air separator 138a is also provided at the first position CH1 on the upstream side CHU (the upper side in FIG. 5, the left-hand side in FIG. 6) of the one-side hot air drying unit 133 located at the most upstream side CHU in the conveying direction CH. The hot air separator 138a suppresses spreading of the one-side hot air HA1 and the other-side hot air HA2 to the upstream side CHU. Furthermore, a hot air separator 138e is also provided at the fifth position CH5 on the downstream side CHD (the lower side in FIG. 5, the right-hand side in FIG. 6) of the other-side hot air drying unit 134 located at the most downstream side CHD in the conveying direction CH. The hot air separator 138e suppresses spreading of the one-side hot air HA1 and the other-side hot air HA2 to the downstream side CHD.

Since the one-side hot air HA1 and the other-side hot air HA2, which have opposite flow directions, are separated by the hot air separators 138b to 138d, the one-side hot air drying unit 133 and the other-side hot air drying unit 134 can be arranged consecutively, and the one-side hot air drying step S31 and the other-side hot air drying step S32 can be performed consecutively. Thus, the undried strip-shaped electrode plate 1xa, 1x can be dried over a short distance in the conveying direction CH.

In particular, in this embodiment, the one-side hot air drying units 133 and the other-side hot air drying units 134 arranged in four stages in the conveying direction are switched at the same second to fourth positions CH2 to CH4 in the conveying direction CH for any of the three strips of undried composite active material layers 5Ax, 5Bx, 5Cx, as described above. Therefore, as shown in FIG. 5, the same hot air separators 138a to 138e can be used for all the three undried composite active material layers 5Ax, 5Bx, 5Cx, and thus can be easily arranged in position.

In this embodiment, the hot air separators 138a to 138e are made of aluminum plates. However, any material capable of withstanding the heat of the one-side hot air HA1, etc., can be used. For example, metal materials such as stainless steel plates, heat-resistant resin materials such as polyimide, or glass materials may be used.

### Modified Embodiment

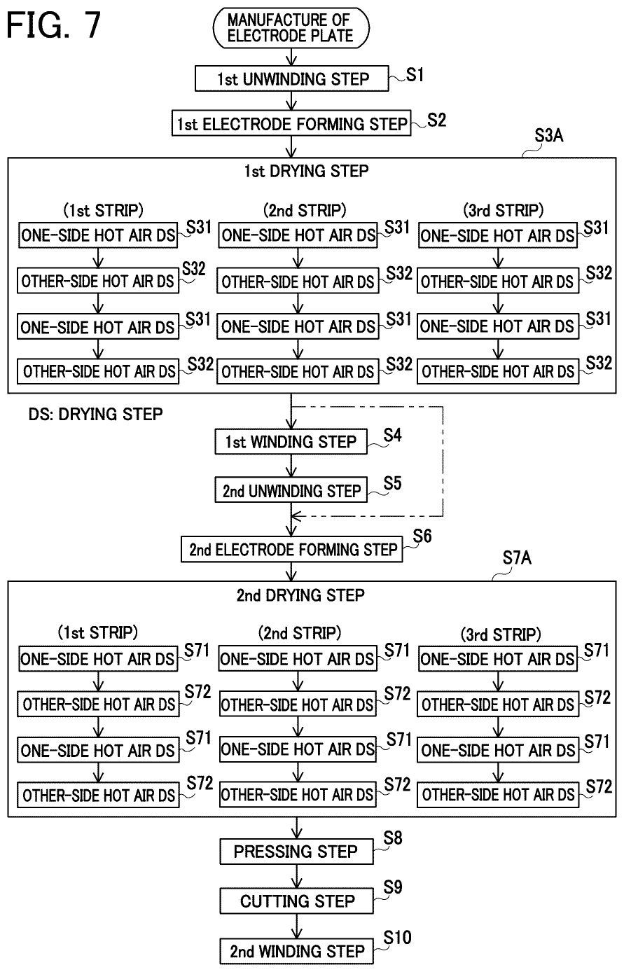

Next, the manufacture of the strip-shaped electrode plate 1 according to a modified embodiment and a drying apparatus 230 used for the manufacture of the strip-shaped electrode plate 1 will be described, primarily with reference to FIG. 7 to FIG. 9. The manufacture of the strip-shaped electrode plate 1 according to the modified embodiment is largely similar to that of the embodiment (see FIG. 2), but the order of the one-side hot air drying steps S31, S71 and the other-side hot air drying steps S32, S72 in a first drying step S3A and a second drying step S7A differs in part. The drying apparatus 230 of the modified embodiment is largely similar to the drying apparatus 130 of the embodiment, but the arrangement of the one-side hot air drying units 133 and the other-side hot air drying units 134 differs in part. Therefore, the different parts will be mainly described, and description of similar parts will be omitted or simplified.

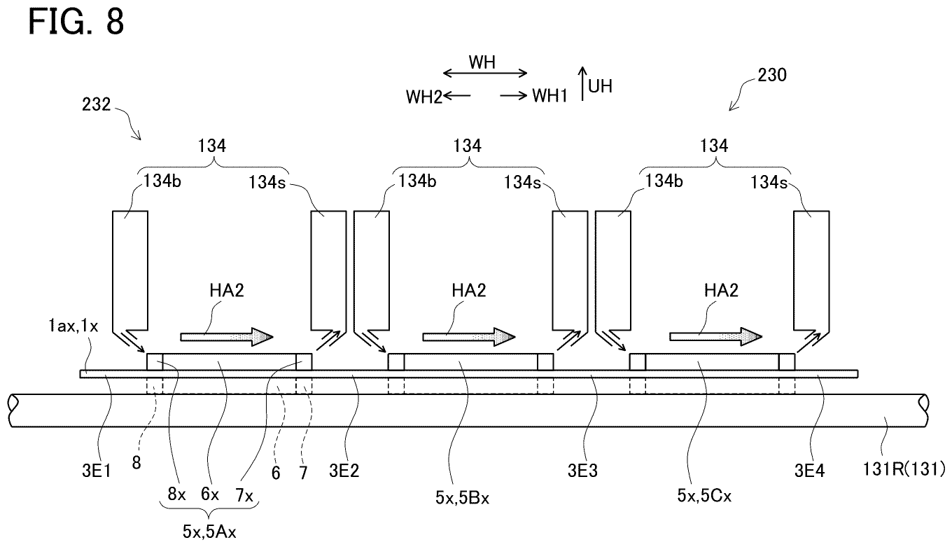

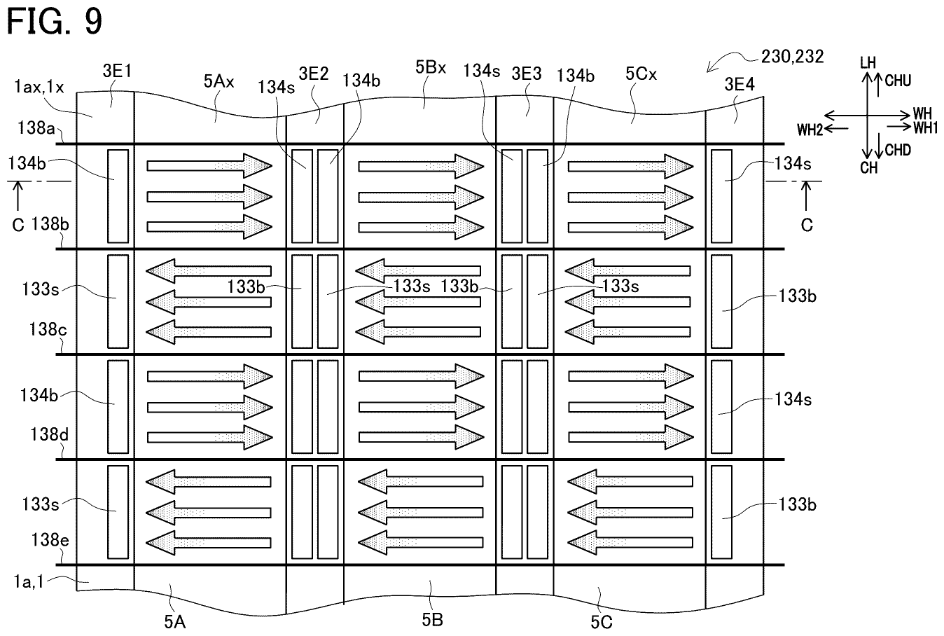

In the first drying step S3A and the second drying step S7A of the modified embodiment, the undried strip-shaped electrode plate 1xa, 1x is dried by the drying apparatus 230 shown in FIG. 6, FIG. 8, and FIG. 9. Like the drying apparatus 130, the drying apparatus 230 comprises a conveying section 131 consisting of a plurality of conveying rolls 31R that convey the undried strip-shaped electrode plate 1xa, 1x in the conveying direction CH aligned with the longitudinal direction LH, and a drying section 132 that dries the undried strip-shaped electrode plate 1xa, 1x with hot air.

In the first drying step S3A, too, the three strips of undried composite active material layers 5Ax, 5Bx, 5Cx formed on the undried strip-shaped electrode plate 1xa are respectively dried to form the strip-shaped electrode plate 1a having three strips of composite active material layers 5A, 5B, 5C. In this step, a total of four hot air drying steps, i.e., two one-side hot air drying steps S31 and two other-side hot air drying steps S32, are alternately performed for each strip of the undried composite active material layers 5Ax, 5Bx, 5Cx. The same applies to the second drying step S7A.

However, in the first drying step S3 and second drying step S7 of the above embodiment, and in the drying apparatus 130 used in these steps, the direction of hot air flow is made different between the undried composite active material layers 5x adjacent to each other in the width direction WH (see FIG. 2, FIG. 4, and FIG. 5).

In contrast, in the first drying step S3A and second drying step S7A of the modified embodiment, and in the drying apparatus 230 used in these steps, the direction of hot air flow is the same for the undried composite active material layers 5x adjacent to each other in the width direction WH. Specifically, as shown in FIG. 7, all of the three strips of undried composite active material layers 5Ax, 5Bx, 5Cx undergo the hot air drying steps in the order of the one-side hot air drying step S31, the other-side hot air drying step S32, the one-side hot air drying step S31, and the other-side hot air drying step S32. For this purpose, as shown in FIG. 8 and FIG. 9, the hot air drying units of the drying apparatus 230 for drying any of the undried composite active material layers 5Ax, 5Bx, 5Cx are arranged toward the downstream side CHD in the conveying direction CH in the order of the other-side hot air drying unit 134, the one-side hot air drying unit 133, the other-side hot air drying unit 134, and the one-side hot air drying unit 133. Thus, the one-side hot air drying units 133 and the other-side hot air drying units 134 are arranged alternately in a total of four stages in the conveying direction CH, and are also arranged in three columns in the width direction WH. Therefore, when multiple strips (three strips in this embodiment) of composite active material layers 5 are formed in the first drying step S3A and second drying step S7A of the modified embodiment, using the drying apparatus 230, each strip of undried composite active material layer 5x can be reliably dried in a short time.

The disclosure has been described above in the light of the embodiment and the modified embodiment. However, the disclosure is not limited to these embodiments, etc., but may be appropriately modified and applied without departing from its principle.

For example, in the embodiments, etc., the strip-shaped current collecting foil 3 made of aluminum is used. However, the disclosure may also be applied when strip-shaped electrode plates having active material layers and protective layers are manufactured using strip-shaped current collecting foils made of copper.

Furthermore, the hot air separators 138a to 138e in the form of hot air separating plates that are elongate in the width direction WH may be used in common for the respective strips of undried composite active material layers 5Ax, 5Bx, 5Cx. Instead, the hot air separators may be installed individually for the respective strips.

### Reference Signs List

CH Conveying direction
CH2, CH3, CH4 Second position, third position, and fourth position (in conveying direction) (Switching positions in conveying direction)
LH Longitudinal direction
WH Width direction
WH1 One side (of width direction)
WH2 Other side (of width direction)
UH Upper side
1, 1a Strip-shaped electrode plate
1x, 1xa Undried strip-shaped electrode plate
3 Strip-shaped current collecting foil
3S1 First surface (Surface) (of strip-shaped current collecting foil)
3S2 Second surface (Surface) (of strip-shaped current collecting foil)
5, 5A, 5B, 5C Active material layer with protective layers
5x, 5Ax, 5Bx, 5Cx Undried active material layer with protective layers
6 Active material layer (Active material layer)
6x Undried active material layer
7 First protective layer
7x Undried first protective layer
8 Second protective layer
8x Undried second protective layer
SV Dispersion medium
130, 230 Drying apparatus
HA1 One-side hot air
HA2 Other-side hot air
133 One-side hot air drying unit (Each-strip one-side hot air drying unit)
134 Other-side hot air drying unit (Each-strip other-side hot air drying unit)
135 Combined hot air delivery section
136 Combined hot air suction section
138a, 138b, 138c, 138d, 138e Hot air separator
S3, S3A First drying step (Drying step)
S31 One-side hot air drying step (Each-strip one-side hot air drying step)
S32 Other-side hot air drying step (Each-strip other-side hot air drying step)
S7, S7A Second drying step (Drying step)
S71 One-side hot air drying step (Each-strip one-side hot air drying step)
S72 Other-side hot air drying step (Each-strip other-side hot air drying step)

What is claimed is:

1. A method of manufacturing a strip-shaped electrode plate including a strip-shaped current collecting foil extending in a longitudinal direction and a plurality of strips of active material layers with protective layers on a surface of the strip-shaped current collecting foil, each of the active material layers with protective layers comprising an active material layer extending in the longitudinal direction, a first protective layer provided on one side in a width direction of the active material layer and extending in the longitudinal direction, and a second protective layer provided on the other side in the width direction of the active material layer and extending in the longitudinal direction, the active material layers with protective layers being arranged in the width direction via foil exposed portions where the strip-shaped current collecting foil is exposed in the shape of strips extending in the longitudinal direction, the method comprising
drying a plurality of strips of undried active material layers with protective layers while conveying an undried strip-shaped electrode plate having the strip-shaped current collecting foil and the strips of undried active material layers with protective layers provided on the strip-shaped current collecting foil, in a conveying direction aligned with the longitudinal direction, each of the undried active material layers with protective layers comprising an undried active material layer that becomes the active material layer when dried, and an undried first protective layer and an undried second protective layer that contain a higher proportion of a dispersion medium than the undried active material layer and become the first protective layer and the second protective layer when dried,
wherein, for each of the strips of undried active material layers with protective layers, each-strip one-side hot air drying of flowing one-side hot air over the undried first protective layer, the undried active material layer, and the undried second protective layer, in the order of description, to dry the undried first protective layer, the undried active material layer, and the undried second protective layer, and each-strip other-side hot air drying of flowing other-side hot air over the undried second protective layer, the undried active material layer, and the undried first protective layer, in the order of description, to dry the undried second protective layer, the undried active material layer, and the undried first protective layer, are alternately performed in the conveying direction.

2. The method of manufacturing the strip-shaped electrode plate according to claim 1, wherein the each-strip one-side hot air drying and the each-strip other-side hot air drying are switched at the same switching positions along the conveying direction with respect to any of the strips of undried active material layers with protective layers.

3. The method of manufacturing the strip-shaped electrode plate according to claim 1, wherein the each-strip one-side hot air drying and the each-strip other-side hot air drying are continuously performed for the undried active material layers with protective layers conveyed in the conveying direction, while separating the one-side hot air and the other-side hot air adjacent to each other in the conveying direction and flowing in opposite directions by use of a hot air separator.

4. The method of manufacturing the strip-shaped electrode plate according to claim 2, wherein the each-strip one-side hot air drying and the each-strip other-side hot air drying are continuously performed for the undried active material layers with protective layers conveyed in the conveying direction, while separating the one-side hot air and the other-side hot air adjacent to each other in the conveying direction and flowing in opposite directions by use of a hot air separator.

5. The method of manufacturing the strip-shaped electrode plate according to claim 3, wherein the hot air separator is provided at the same position in the conveying direction with respect to each of the strips of undried active material layers with protective layers.

6. The method of manufacturing the strip-shaped electrode plate according to claim 4, wherein the hot air separator is provided at the same position in the conveying direction with respect to each of the strips of undried active material layers with protective layers.

7. A drying apparatus for drying an undried strip-shaped electrode plate including a strip-shaped current collecting foil extending in a longitudinal direction and a plurality of strips of undried active material layers with protective layers on a surface of the strip-shaped current collecting foil, each of the undried active material layers with protective layers comprising an undried active material layer extending in the longitudinal direction, an undried first protective layer located on one side in a width direction of the undried active material layer and extending in the longitudinal direction, and an undried second protective layer located on the other side in the width direction of the undried active material layer and extending in the longitudinal direction, the undried active material layers with protective layers being arranged in the width direction via foil exposed portions where the strip-shaped current collecting foil is exposed in the shape of strips extending in the longitudinal direction, the drying apparatus comprising:
a conveying unit that conveys the undried strip-shaped electrode plate with the undried active material layers with protective layers facing upward, in a conveying direction aligned with the longitudinal direction; and
an each-strip one-side hot air drying unit and an each-strip other-side hot air drying unit alternately arranged in the conveying direction, for each of the strips of undried active material layers with protective layers, the each-strip one-side hot air drying unit flowing one-side hot air over the undried first protective layer, the undried active material layer, and the undried second protective layer, in the order of description, to dry the undried first protective layer, the undried active material layer, and the undried second protective layer, the each-strip other-side hot air drying unit flowing other-side hot air over the undried second protective layer, the undried active material layer, and the undried first protective layer, in the order of description, to dry the undried second protective layer, the undried active material layer, and the undried first protective layer.

8. The drying apparatus according to claim 7, wherein the each-strip one-side hot air drying unit and the each-strip other-side hot air drying unit are switched at the same switching positions along the conveying direction with respect to any of the strips of undried active material layers with protective layers.

9. The drying apparatus according to claim 7, further comprising a hot air separator provided between the each-strip one-side hot air drying unit and the each-strip other-side hot air drying unit for separating the one-side hot air and the other-side hot air adjacent to each other in the conveying direction and flowing in opposite directions.

10. The drying apparatus according to claim 8, further comprising a hot air separator provided between the each-strip one-side hot air drying unit and the each-strip other-side hot air drying unit for separating the one-side hot air and the other-side hot air adjacent to each other in the conveying direction and flowing in opposite directions.

11. The drying apparatus according to claim 9, wherein the hot air separator is provided at the same position in the conveying direction with respect to each of the strips of undried active material layers with protective layers.

12. The drying apparatus according to claim 10, wherein the hot air separator is provided at the same position in the conveying direction with respect to each of the strips of undried active material layers with protective layers.
